(19) United States
(12) Patent Application Publication
(10) Pub. No.: US 2011/0281238 A1
(43) Pub. Date: Nov. 17, 2011

(54) Methods for Removing Adhesive Resin from a Dental Tooth

(75) Inventors: Richard Cook, Kent (GB); Timothy Watson, Kent (GB); Ian Thompson, Essex (GB)

(73) Assignee: OSSPRAY LIMITED, Royston, Herts (GB)

(21) Appl. No.: 13/055,285

(22) PCT Filed: Jul. 23, 2009
(86) PCT No.: PCT/GB2009/001836

§ 371 Date: Jul. 27, 2011

(30) Foreign Application Priority Data
Jul. 23, 2008 (GB) 0813494.2

(51) Int. Cl. A61C 3/025

(52) U.S. Cl. 433/216

(57) ABSTRACT

A method of removing an adhesive resin from a dental tooth which method comprises contacting the dental tooth with a bioactive glass using an air abrasion system.

This application is a National Stage Application of PCT/GB2009/001836, filed 22 Jul. 2009, which claims benefit of Serial No. 0813494.2, filed 23 Jul. 2008 in Great Britain and which applications are incorporated herein by reference. To the extent appropriate, a claim of priority is made to each of the above disclosed applications.

The present invention relates to a method of removing glass ionomer or acid-etch-bonded resin adhesives from teeth using bioactive glass in a conventional air abrasion system.

The orthodontic movement of teeth in fixed appliance therapy is achieved by application of forces which are transmitted through brackets bonded to enamel using either glass ionomer or acid-etch-bonded resin adhesives. An essential property of the ideal adhesive is to form a bond to the enamel which is strong enough to resist the large forces placed upon it during treatment, but is easily removed leaving the enamel surface adhesive-free and as histomorphologically unchanged as possible at the end of treatment.

Many clinical techniques exist to de-bond brackets and remove residual adhesive but fall short of this goal, including pliers (1), dental stones (2), high and slow speed burs (3), polishing aids (4), ultrasonic instruments (2), and more recently, the use of laser systems (5). The method most recommended and shown to cause the least damage to enamel, is the water-cooled, slow speed tungsten carbide bur (6, 8, 11, 12, 13, 14).

Rotary cutting techniques generate large amounts of heat and vibration due to the inevitable friction between the cutting surface and the substrate. These can result in sub-surface cracking and unpredictable tooth damage. In addition, the high pitched whine of a dental drill is often accompanied by psychological trauma of the patient.

The process of dental air-abrasion with alumina involves the acceleration of abrasive particles in a stream of compressed gas directed to the tooth through a nozzle (15). The process has been known since the 1950s and is used clinically for the preparation of cavities (16) as well as for increasing the rugosity of enamel prior to orthodontic bracket bonding. In contrast to rotary cutting techniques, the air abrasive technique is a much lower energy technique resulting in less unpredictable cracking of enamel prisms. The findings of Cook et al. (17), who showed alumina air-abrasion to be effective in the removal of composite at a higher rate than sound enamel, indicate that it may be possible for this technique to be used to remove residual orthodontic adhesive resin on sound teeth.

We have now found that by using bioactive glass as an abrasive agent (cutting and/or surface peening agent) in a conventional air abrasion system, benefits are observed in the removal of orthodontic adhesive resin. In particular, the amount of enamel removed using bioactive glass air abrasion is reduced and more predictable leading to improved clinical out comes compared to alumina air abrasion or tungsten carbide bur.

Accordingly the present invention provides a method of removing an adhesive resin from a dental tooth which method comprises contacting the dental tooth with a bioactive glass using an air abrasion system.

### BRIEF DESCRIPTION OF THE FIGURES

FIG. 1: Box and whiskers plot showing the volume of enamel removed (mm³−y axis) using slow speed tungsten carbide bur (TC_Bur), alumina air-abrasion (Al_air-abrasion) and bioactive glass air-abrasion (BG_air-abrasion). The whiskers show the range, the box shows the quartile and the thick horizontal line the median data.

FIG. 2 a: SEM (25×) of enamel following debonding with the TC bur. Scarring can be seen as ridges along the path of the bur (shown by the arrow and parallel to it). There is evidence of creation of planes along the stroke of the bur (shown by {). b: SEM (25×) of enamel following debonding using alumina air-abrasion (AlA). The enamel appears rough and pitted over the abraded area. A step in the enamel is evident along the margin between non-abraded and abraded enamel (shown by the arrow). c: SEM (25×) of enamel following debonding using bioactive glass air-abrasion (BGA). The enamel appears rough and pitted. The margin between abraded and non-abraded enamel (black arrow) is less well defined than that seen in FIG. 2a. A crack on the enamel, present prior to debonding, is seen here to have been preferentially abraded (white arrows). d: SEM (250×) of enamel following adhesive removal with the TC bur. Ridges can be seen on the de-bonded enamel surface which lined up with the long axis of the bur. e: SEM (250×) of enamel following adhesive removal with alumina air-abrasion. The rough enamel surface is seen to have sharp peaks which are closely spaced. f: SEM (250×) of enamel following adhesive removal with bioactive glass air-abrasion. The rough enamel surface had peaks are spaced further apart and are more rounded than those created by the alumina air-abrasion, resulting in a less rough appearance.

As used herein the term “removing an adhesive resin” includes reducing the amount of adhesive resin adhered to the dental tooth.

The term “air abrasion” includes the use of other gases as a propellant (e.g. CO₂ or N₂) and the use of water or other fluids to act as dust suppression agents (regardless of potential contribution to the overall cutting effect) are also included, however delivered—either included in the gas stream or entrained around it (e.g. The Aquacut air abrasive machine—Medivance Instruments Ltd, Harlesden, London).

The term “bioactive glass” as used herein refers to a glass or ceramic material comprising Si-oxide or Si-hydroxide which is capable of developing a surface calcium phosphate/hydroxy-carbonate apatite layer in the presence of an aqueous medium, or at the interface of body tissues and the glass, so producing a biologically useful response.

Bioactive glasses suitable for use with the present invention include the silicon based bioactive glasses derived from the Sol-Gel process (Hench L L., West J K., 1990, The Sol-gel Process, Chem. Reviews, 90, 33-72) or the Melt process (Hench L L., Wilson J., 1993 Introduction to Bioceramics. Publisher: World Scientific).

This study had two aims: to quantify the total extent of damage caused to enamel by the current gold standard (slow speed tungsten carbide bur) as volume of enamel lost and to compare the gold standard for residual resin removal to alumina air-abrasion and bioactive glass air-abrasion. The null hypothesis investigated was that there was no difference in the quantitative and qualitative assessment of enamel damage caused by the gold standard, alumina and bioactive glass air-abrasion systems when attempting to remove residual resin adhesive after debonding orthodontic brackets.

Although it may be possible for a bioactive glass lacking a source of calcium or phosphorus to generate an apatite layer in vivo by utilising endogenous sources of these ions, typically a bioactive glass will comprise a source of at least one of calcium or phosphorous in addition to a source of Si-oxide or Si-hydroxide. Typically the bioactive glass will comprise a source of calcium. Optionally the bioactive glass may contain further hardening and/or softening agents. Such softening agents may be selected from: sodium, potassium, calcium, magnesium, boron, titanium, aluminum, nitrogen, phosphorous and fluoride. Additions of sodium, potassium, calcium and phosphorus are most commonly used, to reduce the melting temperature of the glass and to disrupt the Si networks within it. Optionally, hardening agents such as TiO₂ may be included in the glass composition. Its presence would allow crystallization to occur within its structure, so producing a glass-ceramic material, whose hardness will be greater than that of the glass alone.

Thus, composition ranges for bioactive glasses which may be used with the present invention are as follow:
SiO₂ or Si(OH)₂: 1-100%
CaO: 0-60%
P₂O₅: 0-60%
Na₂O: 0-45%
K₂O: 0-45%
MgO: 0-40%
Plus additions of Na, K, Ca, Mg, B, Ti, Al, P, N and F as necessary.

Preferably, a bioactive glass will contain between 30 and 100% Si-oxide or Si-hydroxide, more preferably between 40 and 85%.

In a further preferred embodiment the bioactive glass will contain between 5 and 60% Ca, more preferably between 30 and 55%. With respect to a source of phosphorus, the bioactive glass will contain between 5 and 40% P, more preferably between 10 and 30%.

Thus, in one embodiment the bioactive glass will comprise SiO₂, CaO and P₂O₅. Preferably the bioactive glass includes from 44 to 86 weight % SiO₂, from 4 to 46 weight % CaO and from 3 to 15 weight % P₂O₅. Preferably the bioactive glass is prepared by the sol gel route and comprises from 55 to 86 weight % SiO₂, from 4 to 33 weight % CaO and from 3 to 15 weight % P₂O₅. Preferably such a bioactive glass has the composition 58 weight % SiO₂, 33 weight % CaO and 9 weight % P₂O₅.

In an alternative embodiment the bioactive glass composition may be prepared by the Melt method such as that described in U.S. Pat. No. 5,981,412. Such a glass may have a composition of from 40 to 51 weight % SiO₂, 23 to 25 weight % CaO, 23 to 25 weight % Na₂O and 0 to 6 weight % P₂O₅. Preferably such a bioactive glass has the composition (by weight): SiO₂—45%; Na₂O—24.5%; CaO—24.5%; and P₂O₅—6%. Such a bioactive glass is available commercially as Bioglass® 45S5.

As mentioned above, hardening and softening components may be added to modulate the hardness of the bioactive glass depending on the nature of the resin to be removed. The Young's modulus for 45S5 bioactive glass is 35 GPa and Vickers Hardness Number (VHN) 458±9.4 and is lower than that of alumina (380 GPa and VHN 2300 respectively (20)). It is thought the reduced hardness and more brittle nature of bioactive glass particles can be utilised to produce a higher rate of removal for the adhesive compared to that of sound enamel, thus more selectively removing the orthodontic resin adhesive.

Particles most suitable for use in the present invention will have a diameter in the range of 1 μm to 1 mm, preferably in the range of 10 μm to 500 μm, more preferably in the range of 15 μm to 75 μm.

The term “adhesive resin” as used herein encompasses all types of adhesive resins used to bond orthodontic brackets to dental teeth. In one embodiment the adhesive resin is a glass ionomer or acid-etch-bonded adhesive resin.

The selective nature of the abrasive powder stream makes this technique a less operator dependent one that a rotary instrument. Use of bioactive powders that ultimately dissolve even if accidentally embedded in soft tissue makes this a very safe technique.

It is to be understood that the present invention covers all combinations of suitable and preferred groups described hereinabove.

The present invention will now be illustrated, but is not intended to be limited, by means of the following examples.

### EXAMPLES

### Materials & Methods

Thirty human premolars, extracted for orthodontic reasons, were collected and stored hydrated at 4° C. for no longer than 4 weeks. The teeth were visually examined (×2.6 magnification) to ensure the enamel surfaces were sound, non-carious and un-damaged following the extraction procedure and after cleaning with a slow speed rotary brush with pumice (Bracon, Etchingham, UK). They were randomly divided into three experimental groups (n=10). Resin replicas of the buccal surfaces of the samples (Araldite 2015, Huntsman Advanced Materials, Everberg, Europe) were made from addition-cured silicone impressions (President, Coltène/Whaledent Ltd, Burgess Hill, UK). The teeth were sectioned horizontally, 2 mm below the cement-enamel junction using a water-cooled diamond-coated rotary blade (Labcut 1010, Agar Scientific, Stansted, UK) and mounted on a roughened Perspex block using thermoplastic compound (Tecbond, Kenyon group, Lancashire, UK) with the buccal surface exposed. Using the same compound, three metal spheres (6 mm TC, Evans Cycles, Crawley, UK) were mounted adjacent to each tooth to act as fixed reference points for the profilometry. The mounted teeth were kept hydrated throughout the experiment. Using a contact profilometer (Triclone, Renishaw, Wotton-under-edge, UK), equipped with a 500 μm diameter ruby, sphere-tipped stylus (A-5000-7632 KV/HH, Renishaw, Wotton-under-edge, UK), the original buccal tooth surface and adjacent spheres were scanned. The Z plane and axis alignment of the Perspex plate were recorded and the stepover distance was set to 4 μm. Calibration of the unit using a calibration ruby sphere and confidence testing using Tracecut24a software (Renishaw, Wotton-under-edge, UK) were carried out at the beginning and end of each scanning session.

Metal orthodontic brackets (3M Unitek) were bonded to the buccal surfaces of the teeth using a non-self etch, resin adhesive system (Unite, 3M Unitek, Monrovia, Calif., USA) according to the manufacturer's instructions and stored hydrated for one week at 37° C. after which, the brackets were removed using de-bonding pliers with a twisting motion. The residual adhesive was removed using a slow-speed, 8-bladed tungsten carbide (TC) bur (Unopent, Germany) in group 1, alumina air-abrasion (AlA) in group 2 (using 27 μm Al abrasive in an Abradent air-abrasion unit (Crystal Mark, Clendale, Calif., USA), air pressure of 60 PSI, powder flow set to 2.2 g/min, full powder reservoir) and bioactive glass air-abrasion (BGA) in group 3 (using the Abradent unit with the same settings and 45S5 bioactive glass (NovaMIne Technology, Alachua, Fla., USA), 27 μm<sieved fraction<53 μm), until the enamel surface was deemed adhesive-free to visual-tactile examination under 2.6× magnification (Orascoptic HiRes, Sybron Dental Specialties, Orange, Calif., USA).

After washing and drying the samples using a 3 in 1 air-water syringe, resin replicas of the buccal surfaces were made and the mounted teeth and reference spheres scanned for a second time using the Triclone profilometer as previously described. The enamel surface was finally polished using prophylaxis with pumice and a final set of resin replicas constructed.

### SEM Analysis

The replicas were sputter-coated with gold (SCD 004 sputter coater, Bal-Tec, Vaduz, Liechtenstein) and viewed using a SEM (S-3500, Hitachi, Wokingham, UK) with an accelerating voltage of 12 KV and working distance 25 mm at ×25 magnification. The examiners noted the number of islands of adhesive which were not removed. Four SEMs of representative areas of the de-bonded surface of all samples were captured at ×250 magnification (working distance 15 mm). The examiners were blind to the original grouping of the teeth throughout the analyses.

### Volumetric Analysis

The captured surfaces were converted to true surface models and subsequently converted to stereolithic files using Tracecut24a software (Renishaw, Wotton-under-edge, UK). These files were imported into Geomagic Studio 8 software (Geomagic, France) for volumetric analysis. Using this software, the surface resulting from the first scan (prior to bonding) was superimposed to the surface resulting from the second scan (following de-bonding and removal of the residual adhesive) of the same sample using the automatic registration of the reference spheres tool, which recognised the reference spheres and subsequently superimposed them. Having the same Z plane and axis alignment for all the samples simplified the process by minimising the computing time for aligning the two scans using the reference spheres. After superimposition, the surfaces were manually cropped to retain only the teeth above their maximum circumference in the horizontal plane and to remove the reference spheres and the volume included between the surfaces was measured.

### Statistics

Data were tested for normality using the Shapiro-Wilk W test (21, 22). The effect of the removal method was compared using one-way Anova (Stata Release 8.2; College Station, Tex. 77845, USA) (α=0.05).

### Results

### Quantitative

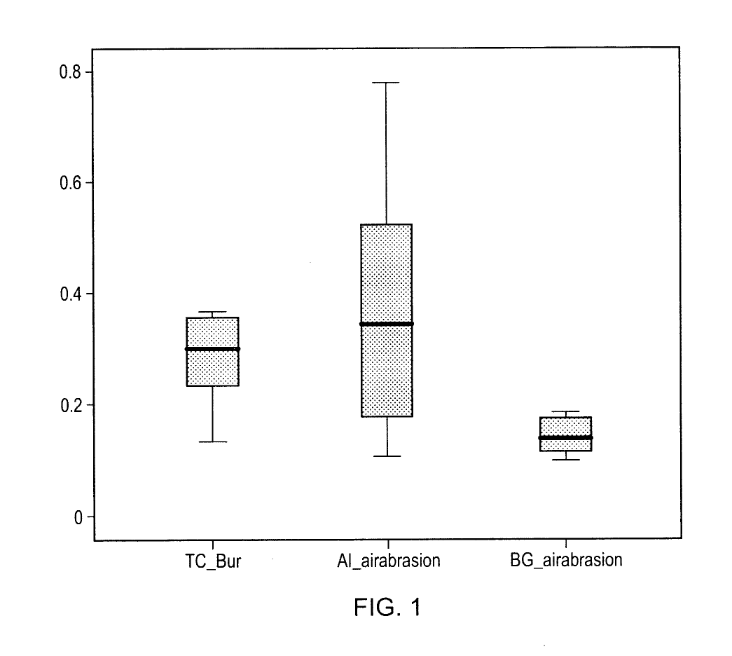

The Shapiro-Wilk W test indicated normality of the test data. Removal of residual adhesive resin using the gold standard TC bur resulted in a mean enamel loss of 0.285 mm³ (Standard Deviation (SD) 0.075), while that for group 2 (AlA) was 0.386 mm³ (SD, 0.254) and group 3 (BGA) 0.135 mm³ (SD, 0.033). The quartile and extreme outliers for the three groups are shown in FIG. 1. Thus, alumina air-abrasion was shown to remove more enamel than the TC bur. Bioglass air-abrasion on the other hand was shown to remove less and importantly had a much narrower inter-quartile range (FIG. 1) than the TC bur, which clinically translates to an improved consistency of performance.

### Qualitative

SEM examination of resin replicas following de-bonding and removal of residual resin, revealed complete removal of adhesive from teeth using all three methods.

### SEM at ×25

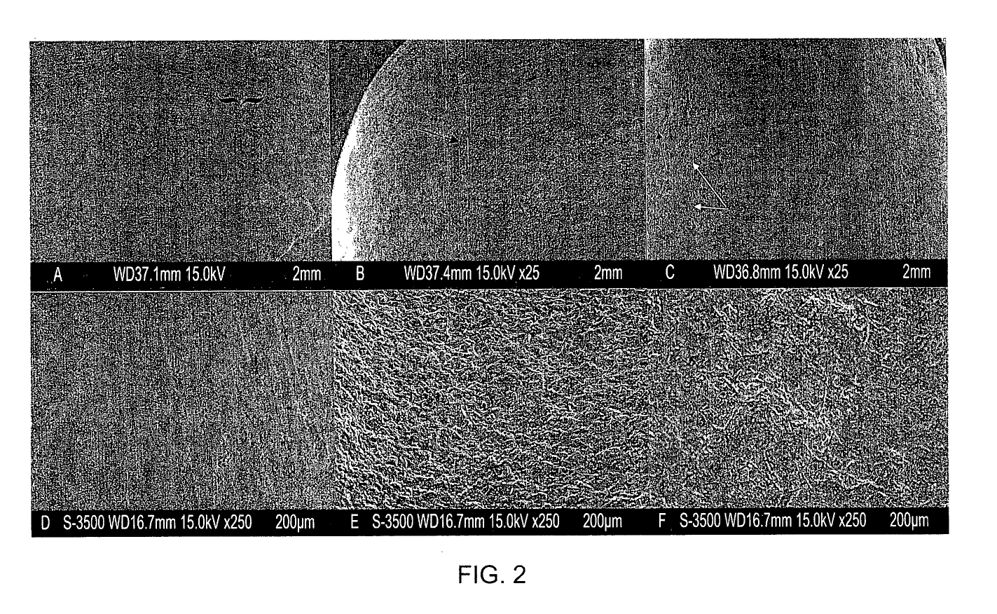

Group 1 (TC): Enamel scarring was seen as ridges along the path of the bur which lined up with its long axis (FIG. 2a). In addition, there was creation of cutting planes along the stroke path of the bur.

Group 2 (AlA): The enamel appeared rough and pitted over the abraded area. In six of the teeth a step in the enamel was evident along the margin between non-abraded and abraded enamel (FIG. 2b).

Group 3 (BGA): The enamel appeared rough and pitted (FIG. 2c), but the margin between abraded and non-abraded enamel was less well defined than that seen in the group AlA and there was no step.

In both air-abrasion groups (AlA & BGA) any surface cracks present were accentuated after the procedure, more so in the AlA group than the BGA group.

### SEM at ×250

Group 1 (TC): Ridges were seen on the de-bonded enamel surface and were lined up with the long axis of the bur (FIG. 2d).

Group 2 (AlA): The rough enamel surface had sharp peaks which were closely spaced (FIG. 2e).

Group 3 (BGA): The rough enamel surface had peaks which were spaced further apart and were more rounded than those created by the alumina air-abrasion, resulting in a less rough appearance (FIG. 20.

### Discussion

The volumetric analysis gave a quantitative measurement of the amount of enamel removed following scanning of the whole bonding surface, allowing comparison of the damage caused by the different adhesive removal methods. The qualitative SEM evaluation gave information about the surface finish achieved, regarding surface irregularities and the restoration of the enamel surface close to its original state.

Removal of adhesive using alumina air-abrasion caused more damage compared to that by the tungsten carbide bur, the “gold standard” used in this study. Moreover, the amount of enamel removed during adhesive removal using alumina air-abrasion was far less predictable than that by TC bur. This finding makes alumina air-abrasion an inappropriate clinical instrument for the removal of residual resin adhesive due to the inherent lack of substrate selectivity of the Al powder. Bioactive glass air-abrasion proved to be significantly less damaging to enamel compared to alumina air-abrasion. More importantly, bioactive glass air-abrasion was proven to be at least as good as the gold standard TC bur in terms of minimising surface enamel damage.

The inter-quartile range of the BGA group data was narrower than that of the TC group. Clinically, this translates to a more predictable result when using bioactive glass air-abrasion that is more acceptable to patients (23). Qualitatively, all three methods appeared to give an acceptable and similar surface finish following a pumice and brush polishing procedure after resin removal. Some samples in the TC group did however exhibit some visible enamel scarring, in contrast to the uniformly polished surface finish achieved in the two abrasion groups. It is interesting that a uniformly polished surface was observed even in the AlA group samples which did exhibit an edge effect, meaning that during polishing some more enamel is removed.

This study has introduced bioactive glass particles as an air-abrasive powder which causes minimal surface damage to enamel and is more predictable than the TC bur gold standard technique.

### REFERENCES

1. KRELL K V, COUREY J M, BISHARA S E. Orthodontic bracket removal using conventional and ultrasonic debonding techniques, enamel loss, and time requirements. American Journal of Orthodontics and Dentofacial Orthopaedics 1993; 103: 258-266.
2. BURAPAVONG V, MARSHALL G W, APFEL D A, PERRY H T. Enamel surface characteristics on removal of bonded orthodontic brackets. American Journal of Orthodontics 1978; 74: 176-187.
3. ZARRINNIA K, EID NM, KEHOE M J. The effect of different debonding techniques on the enamel surface: An in vitro qualitative study. American Journal of Orthodontics and Dentofacial Orthopaedics 1995; 108: 284-293.
4. HOWELL S, WEEKES W T. An electron microscopic evaluation of the enamel surface subsequent to various debonding procedures. Australian Dental Journal 1990; 35: 245-252.
5. AZZEH E, FELDON P J. Laser debonding of ceramic brackets: a comprehensive review. American Journal of Orthodontics and Dentofacial Orthopaedics 2003; 123(1): 79-83.
6. ZACHRISSON BU, ÅRTUN J. Enamel surface appearance after various debonding techniques. American Journal of Orthodontics 1979; 75: 121-137.
8. PUS MD, WAY DC. Enamel loss due to orthodontic bonding with filled and unfilled resins using various clean up techniques. American Journal of Orthodontics 1980; 77: 269-283.
11. ROULEAU B D, MARSHALL G W, COOLEY R O. Enamel surface evaluation after clinical treatment and removal of orthodontic brackets. American Journal of Orthodontics 1982; 81: 423-426.
12. OLIVER R G & GRIFFITHS J. Different techniques of residual composite removal following debonding—time taken and surface enamel appearance, British Journal of Orthodontics 1992; 19: 131-137.
13. HONG Y H, LEW K K K. Quantitative and qualitative assessment of enamel surface following five composite removal methods after bracket debonding. European Journal of Orthodontics 1995; 17: 121-128.
14. RADLANSKI R J. A new carbide finishing bur for bracket debonding. Journal of Orofacial Orthopaedics 2001; 62: 296-304.
15. BLACK R B. Technic for nonmechanical preparation of cavities and prophylaxis. Journal of the American Dental Association 1945; 32: 701-710.
16. BANERJEE A, WATSON T F. Air-abrasion: its uses and abuses. Dental Update 2002; 29: 340-346.
17. COOK R J, AZZOPARDI A, THOMPSON I D, WATSON T F. Real-time confocal imaging, during active air abrasion-substrate cutting. Journal of Microscopy 2001; 203(2): 199-207.
20. THOMPSON I D, HENCH L L. Review paper: mechanical properties of bioactive glass, glass-ceramics and composites. Journal of Engineering in Medicine 1998; 212(2): 127-136.
21. ROYSTON J P. AS R94, Shapiro-Wilk normality test and P-value. Applied Statistics 1995; 44(4): 547-551.
22. CONOVER W J. Practical Nonparametric Statistics (3rd edition). Wiley 1990.
23. RAFIQUE S, FISKE J, BANERJEE A. Clinical trial of an air-abrasion/chemomechanical operative procedure for the restorative treatment of dental patients. Caries Research 2003; 37: 360-364.

1. A method of removing an adhesive resin from a dental tooth which method comprises contacting the dental tooth with a bioactive glass using an air abrasion system.

2. A method according to claim 1, wherein the bioactive glass comprises a source of SiO or Si(OH)₂, and a source of CaO₂ or P₂O₅.

3. A method according to claim 1, wherein the bioactive glass further comprises at least one hardening agent and/or at least one softening agent.

4. A method according to claim 3 wherein the softening agent is selected from Na, K, Ca, Mg, B, Al, P, N, F and the hardening agent is TiO₂.

5. A method according to claim 1, wherein the bioactive glass comprises 1 to 100% SiO₂ or Si(OH)₂, 0 to 60% CaO, 0 to 60% P₂O₅, 0 to 45% Na₂O, 0 to 45% K₂O and 0 to 40% MgO.

6. A method according to claim 1, wherein the bioactive glass is obtainable by the Sol-Gel method.

7. A method according to claim 1, wherein the bioactive glass is obtainable by the Melt method.

8. A method according to claim 1, wherein the bioactive glass comprises 44 to 86 weight % SiO₂, 4 to 46 weight % CaO and 3 to 15 weight % P₂O₅.

9. A method according to claim 1, wherein the bioactive glass comprises 58 weight % SiO₂, 33 weight % CaO and 9 weight % P₂O₅.

10. A method according to claim 1, wherein the bioactive glass comprises 47 to 51 weight % SiO₂, 23 to 25 weight % CaO, 23 to 25 weight % Na₂O and 0 to 6 weight % P₂O₅.

11. A method according to claim 1, wherein the bioactive glass comprises (by weight):
SiO₂—45%
Na₂O—24.5%
CaO—24.5%
P₂O₅—6%.

12. A method according to claim 1, wherein the bioactive glass particles have a diameter of from 10 μm to 500 μm, preferably of from 15 μm to 75 μm.

13. A method according to claim 1, wherein the adhesive resin is a glass ionomer or acid-etch-bonded adhesive resin.

14. A method according to claim 1, which further comprises polishing the dental tooth.
